(19) United States
(12) Patent Application Publication
(10) Pub. No.: US 2011/0153493 A1
(43) Pub. Date: Jun. 23, 2011

(54) DYNAMIC LIMIT FUNDING SOURCE

(75) Inventors: Bhaskara Rao Mulakaluri, Foster City, CA (US); Kushal Chatterjee, Santa Clara, CA (US)

(73) Assignee: EBAY INC., San Jose, CA (US)

(21) Appl. No.: 12/640,988

(22) Filed: Dec. 17, 2009

(51) Int. Cl. G06Q 40/00

(52) U.S. Cl. 705/39

(57) ABSTRACT

Various methods and systems are provided to enable single purchases or payments to be funded from a plurality of funding sources, where the funding sources have dynamically set limits and priorities by the user. When a purchase or payment request is made, funding starts with the highest priority source, up to its limit, and continues with sequentially lower funding sources up the their limits, until the purchase or payment is fully funded.

### BACKGROUND

1. Field of the Invention

The present invention generally relates to on-line payments and more particularly to adding funds from a plurality of sources for on-line payments.

2. Related Art

More and more consumers are purchasing items and services over electronic networks, such as the Internet. Consumers routinely search for and purchase products and services from merchants and individuals alike. The transactions can take place directly between an on-line merchant or retailer and the consumer, where payment is typically made by entering information about a funding source, such as a credit card, debit card, or bank account. The user may also mail a physical check to the seller for payment. Transactions can also take place with the aid of an on-line payment provider, such as PayPal, Inc. of San Jose, Calif. Such payment providers can make transactions easier and safer for the parties.

For example, when a payment is made through a payment provider, the payment is transferred from the user's account with the payment provider. The account may have a pre-existing balance or may be funded from another source, such as a bank account or credit card of the consumer. In that case, the payment provider funds the payment through the selected funding source. However, if the funding source has insufficient funds (e.g., a bank account) or too low a credit limit (e.g., a credit card), the transaction may be denied by the payment provider. The consumer may have other funding sources, but none may have the sufficient funds or credit needed for a purchase. As a result, the merchant may lose a sale, and the consumer may not be able to obtain a desired item.

### SUMMARY

In accordance with one embodiment, a system and method enables a payment to made from multiple funding sources, with each funding source having a user-defined limit. Each funding source may also have a priority set by the user, where a payment is first funded from the source with the highest priority. If the first funding source is not sufficient for the payment, funds are withdrawn from the funding source with the next highest priority. This continues until the full payment amount is reached. As a result, when one or even more funding sources have insufficient funds or credit, a purchase may still be completed because the total amount is funded through multiple funding sources. By allowing the user to set both limits and priorities, funding sources can be selectively used, without depleting a fund's balance or using a fund's maximum credit.

In one embodiment, the user accesses the user's account on a payment provider site. A dynamic limit funding source (DLFS) or similar option is selected, such as in a user profile, where the user can add any number of funding sources. The funding sources can be selected from ones already associated with the user's account, in which case the user simply selects the desired source(s). The user may also add new sources, which may be performed by entering the appropriate information, such as account number, routing number, credit card number, verification code, billing address, etc. Funding sources may include bank accounts, savings accounts, credit card accounts, debit cards, etc. For each selected funding source, the user may enter a priority (from 1 to N, where N is the number of funding sources selected) and a limit.

When the user wishes to make a purchase, such as through the payment provider, the payment may be funded through conventional means, such as a single credit card or bank account with no user-defined limits, or through the DLFS account. If funded through the DLFS account, the user may choose the current sources, priorities, and limits, or the user may add/delete funding sources and/or revise priorities and/or limits. The user may then proceed with payment, where the payment provider first uses the funds from the highest priority funding source. If the limit of that source is insufficient, funds from the next highest priority funding source are used up to the user-defined limit. This proceeds until the full amount of the payment is reached. At that time, a notification may be provided to the user and/or the merchant that payment has been made.

These and other features and advantages of the present invention will be more readily apparent from the detailed description of the embodiments set forth below taken in conjunction with the accompanying drawings.

### BRIEF DESCRIPTION OF THE FIGURES

FIG. 1 is a flowchart showing a process a user performs for using a dynamic limit funding source (DLFS) according to one embodiment;

FIG. 2 is a flowchart showing a process a payment provider performs for processing a payment using a dynamic limit funding source according to one embodiment;

FIGS. 3A-3G are screen shots showing various screens the user sees when using a DLFS according to one embodiment;

FIG. 4 is a block diagram of a networked system configured to make a payment using DLFS in accordance with an embodiment of the invention; and

FIG. 5 is a block diagram of a computer system suitable for implementing one or more components of the system in FIG. 4 according to one embodiment.

Embodiments of the present disclosure and their advantages are best understood by referring to the detailed description that follows. It should be appreciated that like reference numerals are used to identify like elements illustrated in one or more of the figures, wherein showings therein are for purposes of illustrating embodiments of the present disclosure and not for purposes of limiting the same.

### DETAILED DESCRIPTION

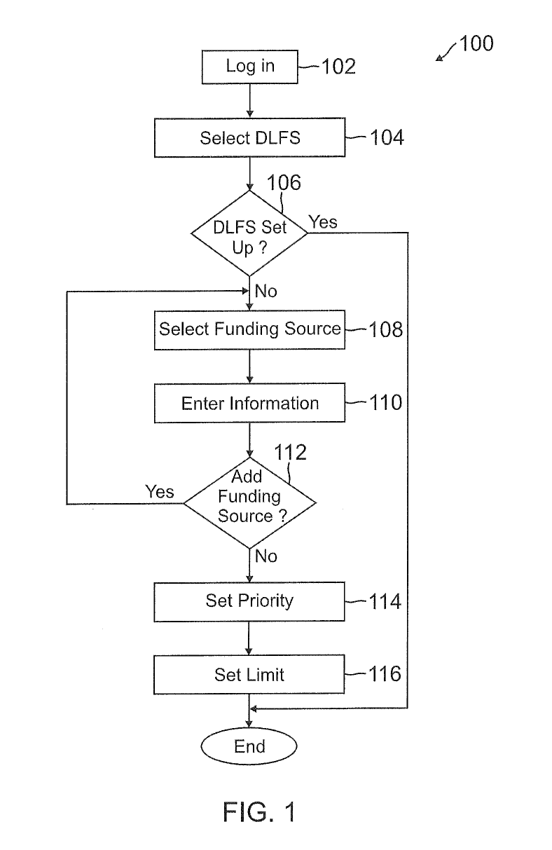

FIG. 1 is a flowchart 100 showing a process a user or consumer performs in utilizing a dynamic limit funding source (DLFS) for making a payment for a purchase according to one embodiment. At step 102, the user logs into a payment provider website, such as PayPal, to access the user's account. The log in process may include accessing the website through a user device, such as a PC or smart phone, via an Internet browser. A user identifier, e.g., a user name or email address, and a password or PIN may then be entered to access the user's account. Next, at step 104, the user selects a DLFS option, such as selecting from a drop-down menu or clicking on a link in a user profile.

A determination is made, at step 106, whether the user has set up the DLFS option. If not, the user first selects a type of funding source, such as a credit card, a bank savings account, a bank checking account, a debit account, etc., at step 108. Based on the type, the user then enters requested information at step 110. For example, if the selected funding source is a credit card, the user may enter the type of credit card, the credit card account number, date of expiration, security code, and/or billing address. If the selected funding source is a checking account, the user may enter the routing number and account number. The user is then asked, at step 112, whether more funding sources are to be added. If so, steps 108 and 110 are repeated to select a second funding source. This continues until all desired funding sources are selected. Note that the selected funding sources may include more than one of any single type of funding source, e.g., the user may select three different credit cards and two different bank accounts. The funding sources will be used in some combination and priority to fund a payment.

Once all desired funding sources are selected, the user may set a priority for each funding source at step 114. The priority determines the sequence that the selected funding sources are used. In one embodiment, if there are N different funding sources, each of the N funding sources are assigned a number from 1 to N. Thus, all selected funding sources may be used for a purchase or payment. In another embodiment, if there are N different funding sources, each of the N funding sources are assigned number starting from 0. In this embodiment, there may be funding sources that cannot be used for funding, i.e., funding sources that are given a 0 priority. One advantage of this embodiment is that the user can enter all possible funding sources at once (e.g., at set up) and then selectively “delete” and “add back” funding sources for any individual purchase or payment.

The user then sets a limit for each funding source at step 116. Note that the priority and limit may be set at the same time or in different order. The limit sets a maximum amount that the payment provider may use in funding a purchase by the user. The limit may be less than the maximum limit imposed by the funding source. For example, if one of the funding sources is a credit card with a credit card issuer credit limit of $5,000, the user may set the limit for this credit card at only $400 for the DLFS funding option. A second funding source may be a checking account, which the user usually keeps at a balance of not less than $1000, but the user may set the limit for this funding source at only $200. However, if desired, the user may set the DLFS limit at the maximum. Note that the priority and/or limit may be set when a funding source is selected instead of waiting until all funding sources are selected.

Once all desired funding sources are set up, along with associated limits and priorities for each, the DLFS option is completed, such that when a DLFS funding is desired, the purchase amount is first funded from the highest priority funding source up to the limit of that funding source, following sequentially by the second and subsequent funding sources and limits, as needed. Thus, the user designates the order and limit of funding. The user may be presented with a page showing the funding source (e.g., last four digits of account or other identifier), priority, and limit. The page provides the user with a summary of the DLFS options, as well as an opportunity to edit any information from the options and add new funding options if desired. This may be accomplished with simple “update” and “add” buttons that the user selects, which then displays pages/requests for updating or adding.

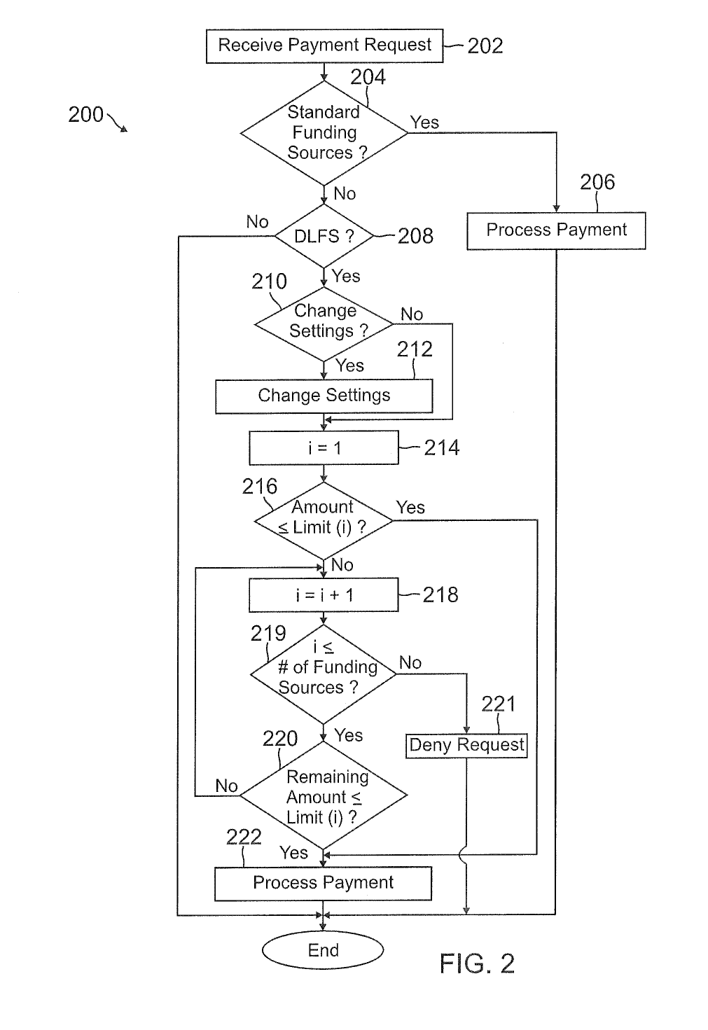

FIG. 2 is a flowchart 200 showing a process a payment provider, such as PayPal, Inc. of San Jose, Calif., performs when processing a payment transaction using DLFS according to one embodiment. At step 202, a payment request is received, such as by a merchant, on-line shopping site, individual seller, or the consumer/buyer. For example, during an on-line transaction, a merchant may transmit to a payment provider, a request by the consumer to make a payment for a purchase. In another example, an individual transmit a request to a payment provider to make a payment to another individual. Once a payment request is received, the payment provider determines, such as at steps 204 and 208, the appropriate funding source for making the payment on behalf of the consumer or user. In one embodiment, a determination is made at step 204 whether payment is to be made with standard funding source(s). For example, the user may have a credit card or bank account on file with the payment provider, which is used for standard or conventional payment funding. Another standard funding is by instant transfer, such as through the user's bank account. The payment provider may determine if standard funding is desired by a user selection or by a user-defined default. If the payment is with a standard funding source, the payment provider then processes the payment at step 206 using conventional processing, such as withdrawing the desired amount from the funding source and transferring the desired amount to the merchant's account or vice versa.

If standard funding is not to be used, a DLFS option may be used, as determined at step 208, such as by user selection of that option. Even when a DLFS option is selected, the user may want to change the current options, as determined at step 210. For example, the user may want to change the priority and/or limit on one or more selected funding sources. Thus, when the DLFS option is selected, the user may be given an opportunity to change the DLFS settings, such as by clicking on a “change” button. The payment provider then changes the settings, at step 212, as made by the user. The user may want to change settings for any number of reasons, such as an earlier selected funding source no longer being valid, having a lower credit or amount of funds available, or having a higher credit or amount of funds available. The settings may also be changed because the user recently obtained a new funding source, such as a new credit card that the user wants to use as a primary funding source.

Once the DLFS settings are correct (either changed or unchanged), a counter is initialized to one at step 214. This counter is used to sequentially determine the funding sources used for the payment. The system first determines, at step 216 whether the payment amount is less than or equal to the limit of the highest priority funding source (indicated by index 1). If so, the payment is processed at step 222, where the amount is funded solely from the first priority funding source. If not, the counter is incremented by one at step 218, and a determination is made at step 219 whether more funding sources are available. If there are no more funding sources available, the payment request is denied at step 221. For example, if the payment amount is $300, and the limit of the first or highest priority funding source is $400, then the full payment amount is funded by the first funding source. If the payment amount is $500, however, only the first $400 is funded from the first funding source, and if there are no more funding sources available, then the payment request may be denied.

When the limit is less than the payment amount, a determination is made at step 220 whether the remaining payment amount is less than or equal to the limit of the second funding source or the second highest priority funding source (indicated by index 2). If so, the payment is processed at step 222, where the payment is funded from 100% of the limit from the first funding source and the remaining payment amount is funded from the second funding source. Using the above example with the $500 payment amount, if the second funding source has a limit of $200, $400 is funded from the first source and $100 is funded from the second source.

If the remaining payment amount is still higher than the limit of the second funding source, processing continues with the counter incremented at step 218 (to i=3 for the third highest priority source) and the limit of the third funding source checked against the new remaining payment amount. This process continues until the payment amount is fully funded from the funding sources or the funding sources have been exhausted. At step 222, the payment is processed, e.g., with the payment provider withdrawing the appropriate amount of funds from the funding source(s), as determined above, and depositing the total in a recipient account. In one embodiment, the recipient receives only one deposit for the full payment amount from the payment provider. Optionally, the payment provider may notify the sender and/or the recipient of a completed payment transfer, such as by email, text, or automated phone call.

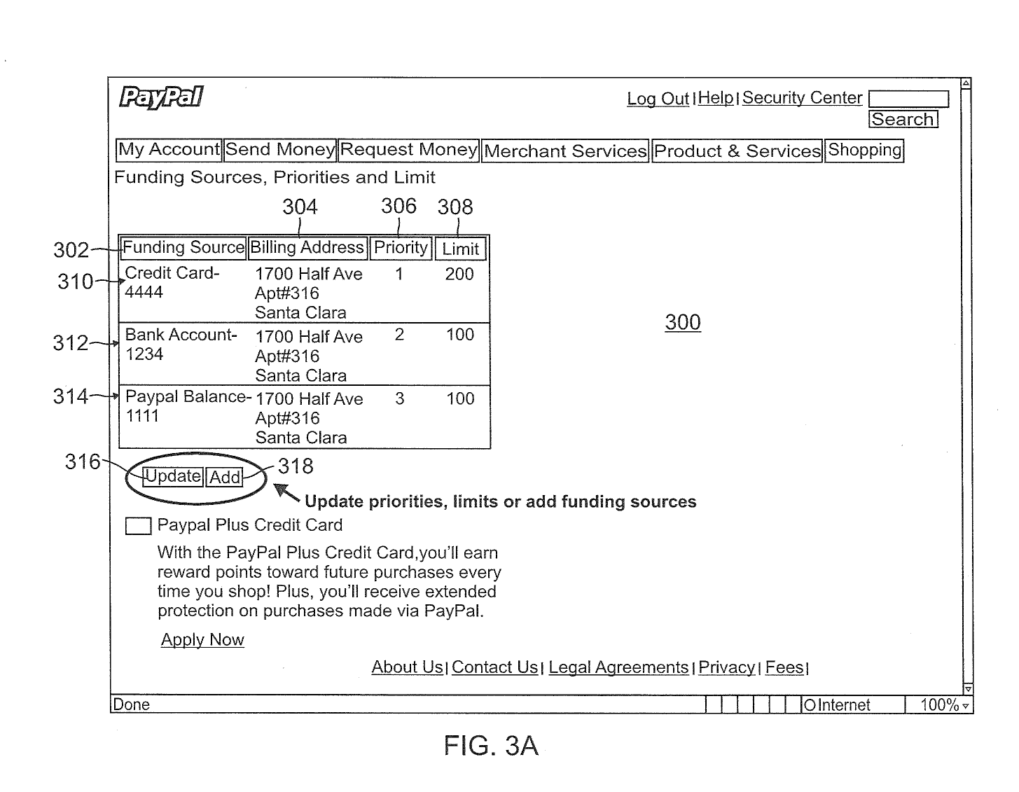

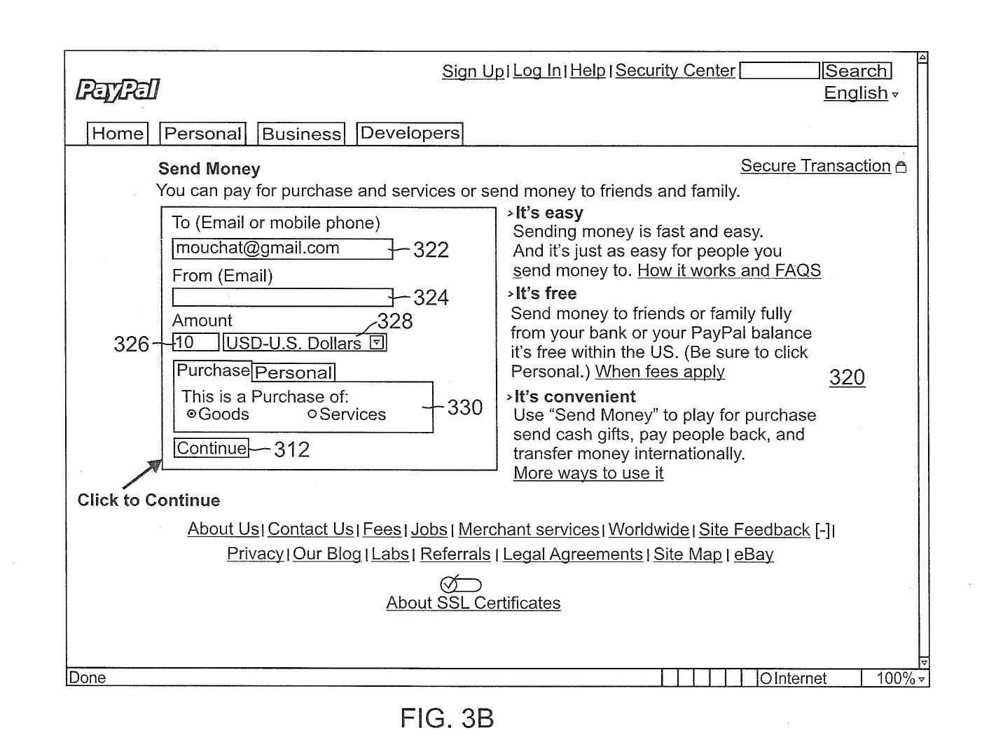

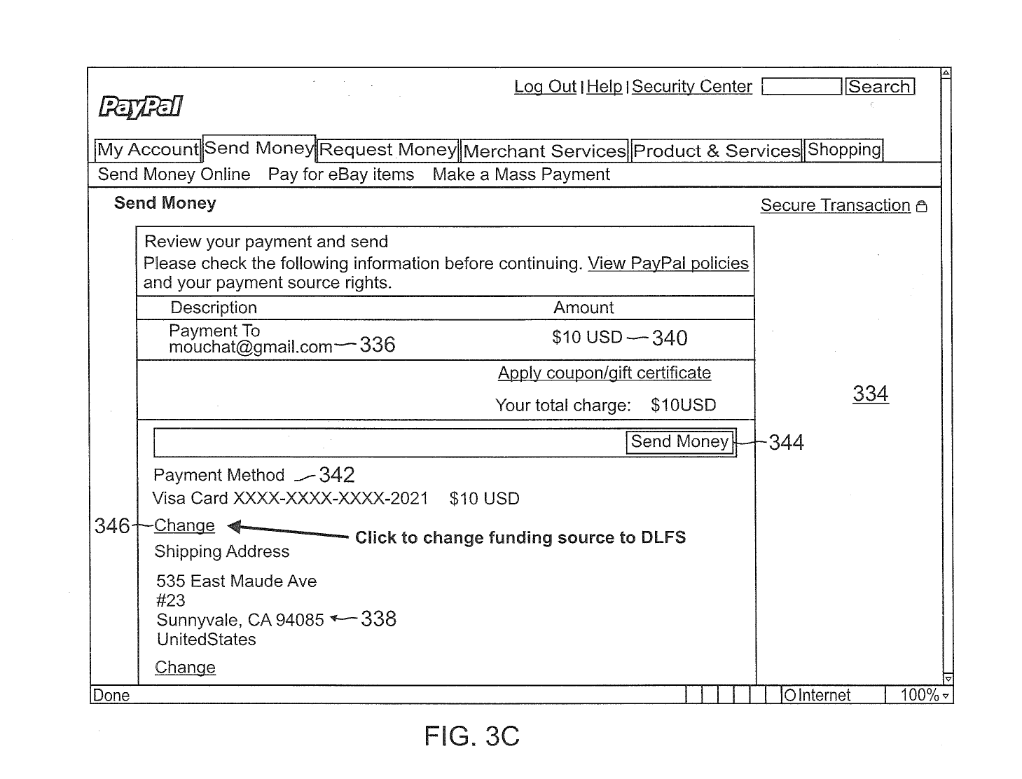

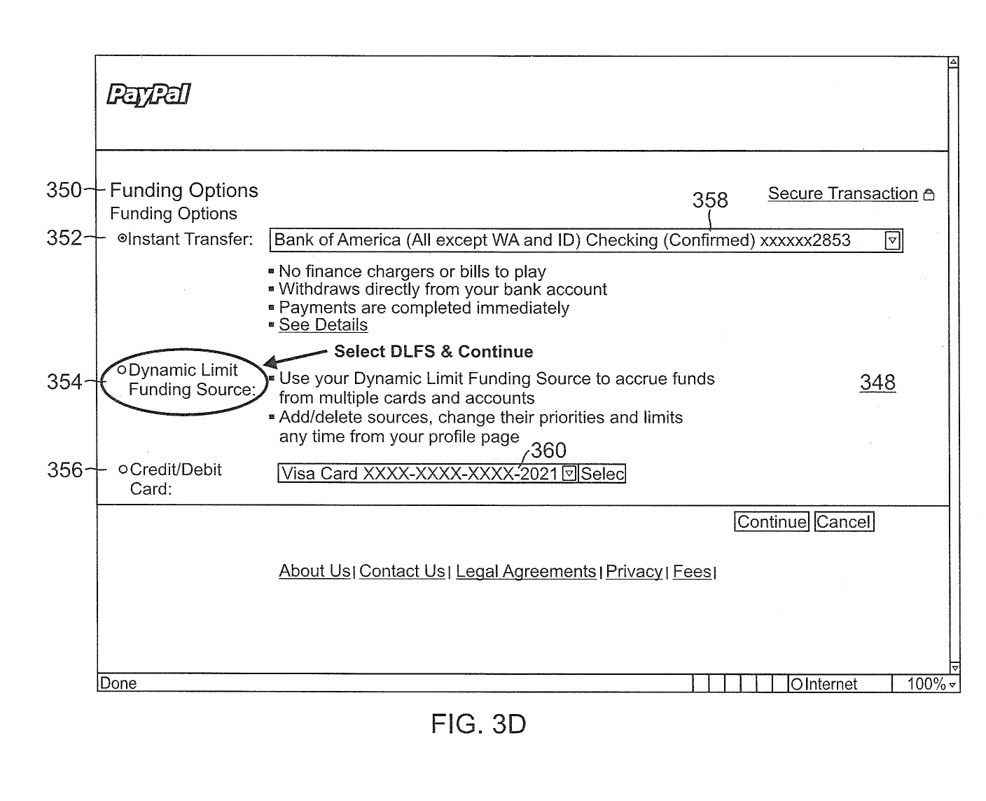

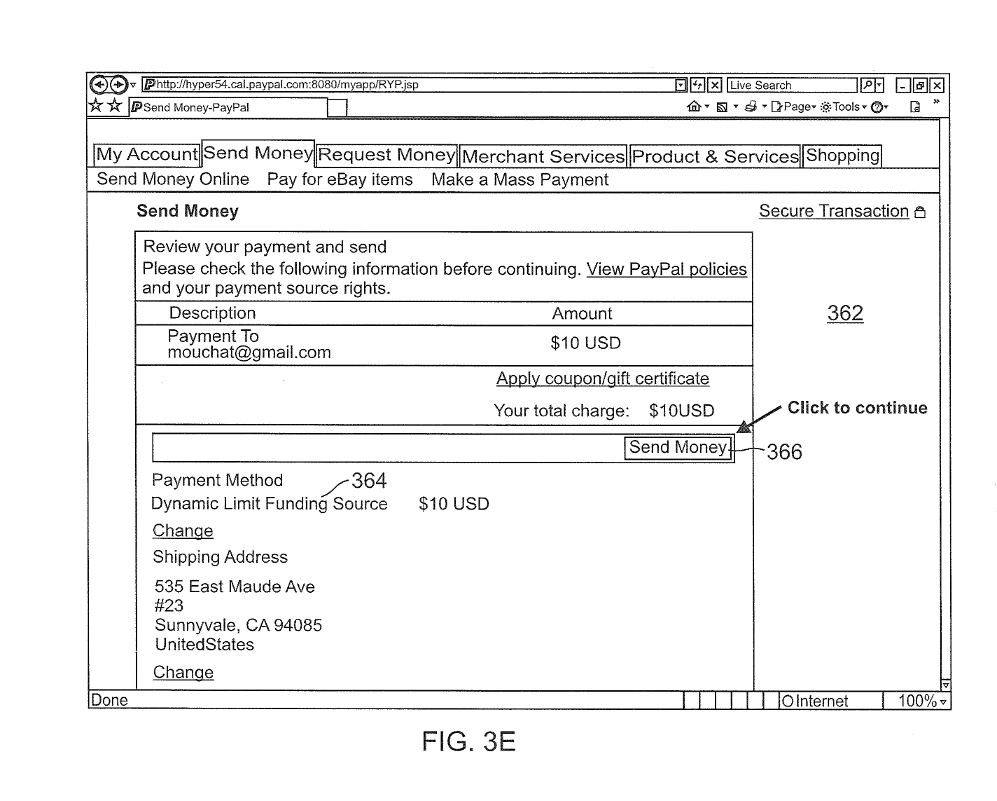

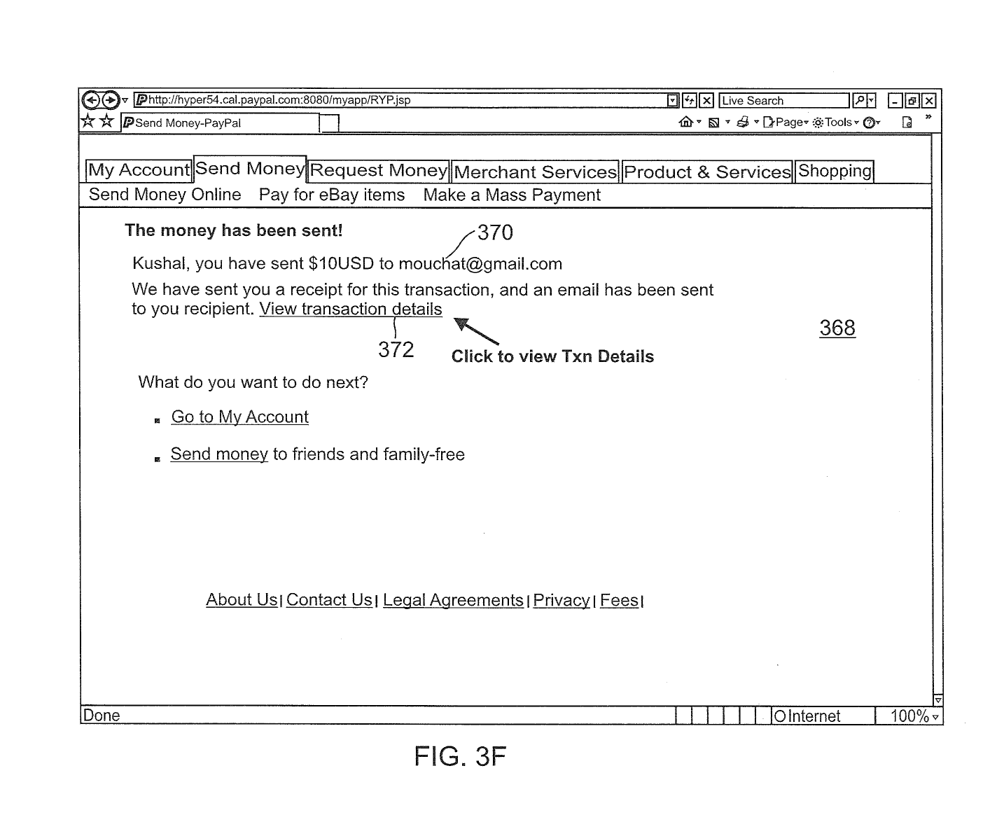

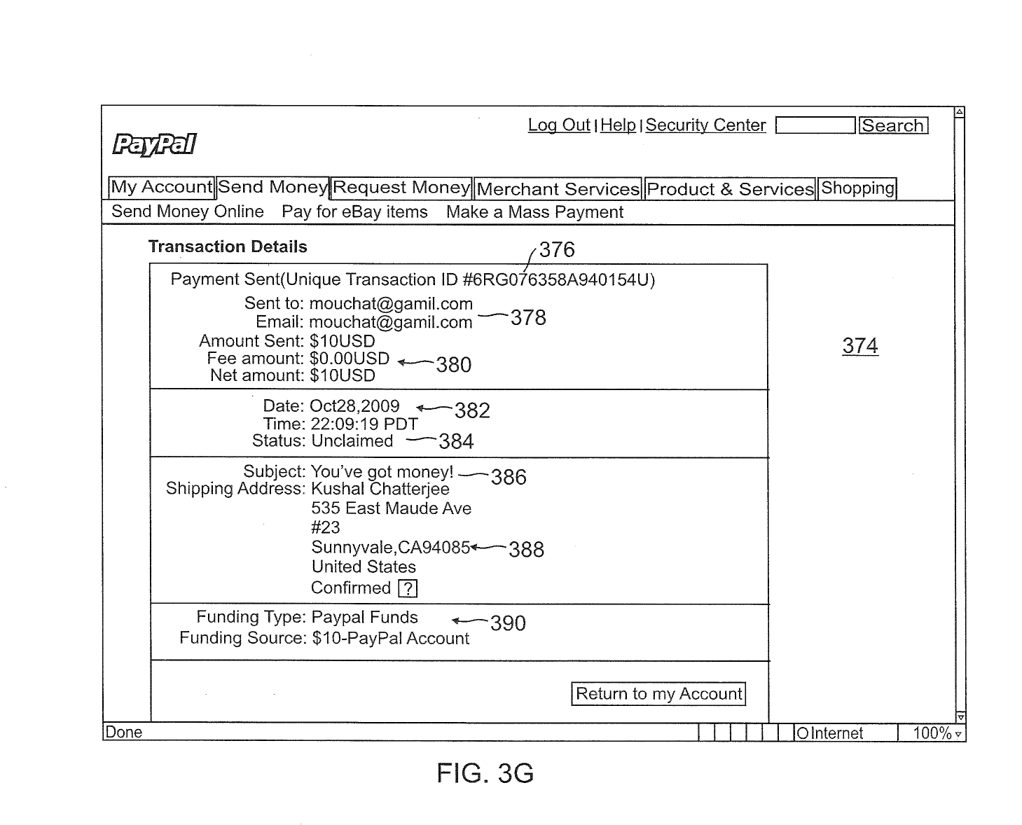

FIGS. 3A to 3G are exemplary screen shots that a user may see or be presented with by the payment provider during a payment process using DLFS, according to one embodiment. In FIG. 3A, a screen shot 300 is displayed after the user has accessed the DLFS option or account, such as through the payment provider site. The user sees a listing with a funding source heading 302, an optional billing address heading 304, a priority heading 306, and a limit heading 308. In this example, the user has three funding sources. The first funding source is a credit card 302, with the last four numbers shown for identification, which is the first priority for funding a payment up to a limit of $200. The billing address may also be shown under heading 304. However, heading 304 may be omitted (e.g., if all the billing address are the same) or be replaced with a different heading.

The second funding source is a bank account 312, with the last four numbers again shown for identification, which is the second highest priority funding source having a limit of $100. The third funding source is a payment provider account (such as an account with the same payment provider as the one offering the DLFS option), with the last four numbers of the account again shown for identification. This account has the third and lowest priority, with a maximum funding amount of $100. Thus, in this example, the credit card is first use for funding a purchase or payment, followed by the bank account, followed by the payment provider account. A maximum of $400 can be funded using the DLFS option.

The user may want to change settings on the current funding sources, such as priorities and/or limits, e.g., when a high priority funding source is at or near its total limit (e.g., nearing the credit line of the credit card) or when a high dollar purchase or payment is anticipated. An update button 316 enables the user to update or change the settings by clicking on the button, which may then allow the user to enter or type in a new priority and/or limit for any of the current funding sources.

The user may also want to add a new funding source, such as when the user obtains a new credit card. This may be accomplished through the user selecting or clicking on an add button 318. The user is then presented with fields to enter the requested information about the new funding source, such as type, account number, billing address, etc., as well as a priority and limit for the new funding source.

FIG. 3B is a screen shot 320, which the user may see when a payment request is made. A recipient is identified at field 322, which may be a mobile phone number or an email of the recipient. A payment may be made to individuals or merchants for a purchases of goods or services or a simple money transfer may be made. A sender email 324 may be entered to identify the sender of the funds. The amount of funds sent may be entered or revised by the user in field 326, such as selecting the field and typing in a desired amount. A drop down menu 328 gives the user the option of selecting the type of funds, such as U.S. dollars, Euro, or any other currency available for transfer. This provides convenience for payment in local currency rather than determining a conversion between currencies. Field 330 allows the user to identify the purpose of the payment, e.g., goods or services when a purchase is made. A “continue” button 332 is selected to re-direct the user to the next screen shot.

FIG. 3C is a screen shot 334 that provides the user with a summary page for review before committing to the payment. The summary includes an email address 336 of the recipient or other identifying information and a shipping or mailing address 338 of the recipient, as well as a payment amount and currency type 340. A payment or funding method 342 is also shown. In this example, the payment method is with a credit card. If everything is correct, the user may select a “Send Money” or similar button 344 to process the payment. However, if the user wants to change the payment method from a credit card to the DLFS option, a “change” button 346 may be selected.

FIG. 3D is a screen shot 348 that may be shown to the user when the user wishes to change a payment method or funding source. A funding options header 350 lists available types of funding sources, such as an instant transfer 352, a DLFS option 354, and a credit card/debit card 356. Each available option has a selection field the user can click on to select that particular funding option. With instant transfer 352, the user is also provided with a drop-down menu 358 with available funding options, typically, a confirmed checking or savings bank account. With credit card/debit card 356, the user is provided with a drop-down menu 360 showing available credit cards and debit cards the user may use. For security purposes, the bank account and credit/debit card information may only show the last four digits of the account or card number, along with any other identifiers as needed.

FIG. 3E is a screen shot 362 of a summary page when the user has selected the DLFS option for funding. As seen, payment method 364 now shows “Dynamic Limit Funding Source.” If no other changes were made, all other information on the summary page remains the same. If the information is correct, the user may select a “send money” button 366 to process the payment, using the selected payment method.

FIG. 3F is a screen shot 368 after the user has confirmed a payment, such as selecting “send money” button 366 in FIG. 3E. The payment confirmation page may include a written confirmation with recipient information and amount sent 370. The user may select a link, such as link 372, to view additional details of the transaction or payment.

FIG. 3G is a screen shot 374 showing transaction details. The page includes a unique transaction identifier 376, which can be used for later reference, recipient information 378, such as email address, an amount sent 380, including currency of the amount, a date and time the amount was sent 382, and a status 384 of the payment, which may be “unclaimed” or “claimed.” The transaction detail page may also include a subject 386 for an email sent to the recipient, along with shipping information 388 of the recipient. Funding information 390 for the payment may be provided to show the user the type of funding and amount.

Thus, the user is able to combine multiple funding sources according to specific user needs. For example, the user can choose any combination of desired funding sources, add them up to pay for a large amount and yet control the amount being spent from each (using the limits) of the sources. There may be users who want to buy items of higher price and yet have to refrain from doing so because of available funds in their individual funding sources insufficient. The ability to use multiple funding sources for a single payment will enable a user to purchase such higher priced items. By also having the ability to set limits, the user may easily limit the balance carried by any particular funding source, such as a credit card, which may eliminate or reduce interest charges. Additional advantages include enabling users with lower income and credit range, e.g., students and younger people, to purchase higher priced items and increasing credit scores by controlling balances and payments for individual credit cards.

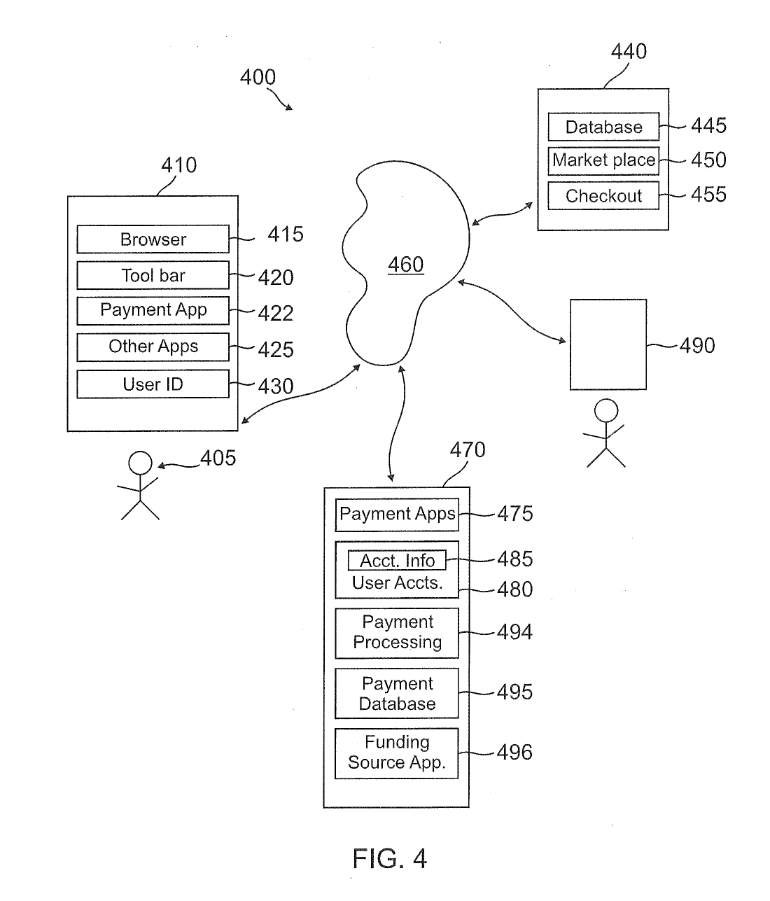

FIG. 4 is a block diagram of a networked system 400 configured to handle a payment transaction, such as described above, in accordance with an embodiment of the invention. System 400 includes a first user or consumer device 410, a second user or consumer device 490, a merchant server 440, and a payment service provider server 470 in communication over a network 460. Payment service provider server 470 may be maintained by a payment provider, such as PayPal, Inc. of San Jose, Calif.

First user device 410, second user device 490, merchant server 440, and payment service provider server 470 may each include one or more processors, memories, and other appropriate components for executing instructions such as program code and/or data stored on one or more computer readable mediums to implement the various applications, data, and steps described herein. For example, such instructions may be stored in one or more computer readable media such as memories or data storage devices internal and/or external to various components of system 400, and/or accessible over network 460.

Network 460 may be implemented as a single network or a combination of multiple networks. For example, in various embodiments, network 460 may include the Internet or one or more intranets, landline networks, wireless networks, and/or other appropriate types of networks.

First user device 410 and second user device 490 may be substantially similar. Therefore, for brevity, only first user device 410 will be described. First user device 410 may be implemented using any appropriate combination of hardware and/or software configured for wired and/or wireless communication over network 460. For example, in one embodiment, first user device 410 may be implemented as a personal computer of a user 405 in communication with the Internet. In other embodiments, first user device 410 may be implemented as a smart phone, personal digital assistant (PDA), notebook computer, and/or other types of computing devices capable of wireless computing, data transmission, and data receiving.

As shown, first user device 410 may include one or more browser applications 415 which may be used, for example, to provide a convenient interface to permit user 405 to browse information available over network 460. For example, in one embodiment, browser application 415 may be implemented as a web browser configured to view information available over the Internet, such as a merchant site or shopping site. First user device 410 may also include one or more toolbar applications 420 which may be used, for example, to provide client-side processing for performing desired tasks in response to operations selected by user 405. In one embodiment, toolbar application 420 may display a user interface in connection with browser application 415 as further described herein.

In addition, first user device 410 may include a payment application 422 that enables payments to be processed, sent, received by the device. As discussed above, payment processing may be with a merchant or individual.

First user device 410 may further include other applications 425 as may be desired in particular embodiments to provide desired features to first user device 410. For example, applications 425 may include security applications for implementing client-side security features, programmatic client applications for interfacing with appropriate application programming interfaces (APIs) over network 460, or other types of applications. Applications 425 may also include email and texting applications that allow user 405 to send and receive emails and texts through network 460. First user device 410 may include one or more user identifiers 430 which may be implemented, for example, as operating system registry entries, cookies associated with browser application 415, identifiers associated with hardware of first user device 410, or other appropriate identifiers, such as used for payment/user/device authentication. In one embodiment, user identifier 430 may be used by a payment service provider to associate user 405 with a particular account maintained by the payment service provider as further described herein.

Merchant server 440 may be maintained, for example, by an on-line merchant or shopping site offering various products and/or services in exchange for payment, which may be received over network 460. Merchant server 440 may include a database 445 identifying available products and/or services (e.g., collectively referred to as items) which may be made available for viewing and purchase by user 405. Accordingly, merchant server 440 also includes a marketplace application 450 which may be configured to serve information over network 460 to browser 415 of first user device 410. In one embodiment, user 405 may interact with marketplace application 450 through browser applications over network 460 in order to view various products or services identified in database 445.

Merchant server 440 may also include a checkout application 455 configured to facilitate the purchase by user 405 of goods or services identified by marketplace application 450. Checkout application 455 may be configured to accept payment information from user 405 and/or from payment service provider server 470, through any number of different funding sources, over network 460.

Payment service provider server 470 may be maintained, for example, by an online payment service provider which may provide payment on behalf of user 405 to the operator of merchant server 440 or to another user, such as of second user device 490. Payment service provider server 470 may include one or more payment applications 475 configured to interact with first user device 410, second user device 490, and/or merchant server 440 over network 460 to facilitate the purchase of goods or services by user 405 of user device 410 from merchant server 440 or another user, as well as transfer money between entities or individuals. In one embodiment, payment service provider server 470 is provided and maintained by PayPal, Inc.

Payment service provider server 470 also maintains a plurality of user accounts 480, each of which may include account information 485 associated with individual users. For example, account information 485 may include private financial information of users of devices such as account numbers, passwords, phone numbers, credit card information, bank information, or other financial information which may be used to facilitate online transactions by user 405. Advantageously, payment application 475 may be configured to interact with merchant server 440 or second user device 490 on behalf of user 405 during a transaction with checkout application 455 or second user device 490 to track and manage purchases or money transfers made by users.

Payment application 475 may include a mobile payment processing application 494 which may be configured to receive information from a mobile user device and/or merchant server 440 for storage in a payment database 495. Payment application 475 may be further configured to match data received from a mobile device with information stored in payment database 495 for payment authentication and processing. As discussed this data may include the user's device phone number, email, password, and/or PIN. A funding source application 496 may also be included as part of payment application 475 or separate. Funding source application 496 may authenticate, authorize, prioritize, and determine amounts of funding for different funding sources a specific user, such as steps in using a DLFS discussed above.

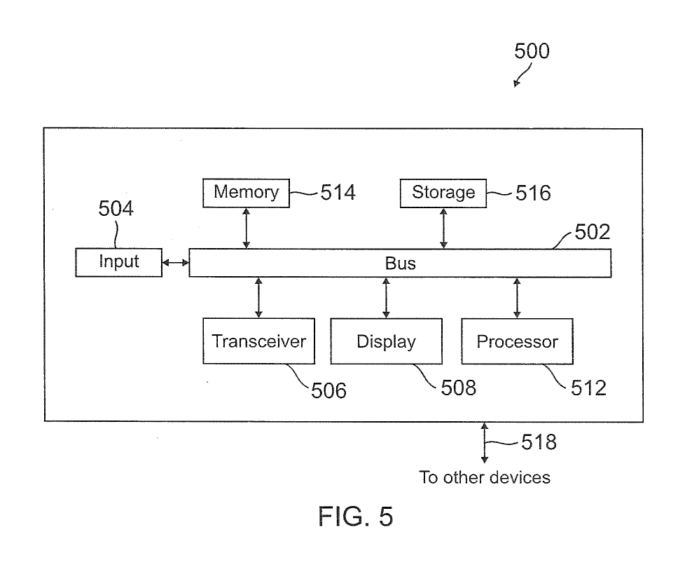

FIG. 5 is a block diagram of a computer system 500 suitable for implementing one or more embodiments of the present disclosure. In various implementations, the user device may comprise a personal computing device (e.g., a personal computer, laptop, smart phone, PDA, etc.) capable of communicating with the network. The merchant and/or payment provider may utilize a network computing device (e.g., a network server) capable of communicating with the network. It should be appreciated that each of the devices utilized by users, merchants, and payment providers may be implemented as computer system 500 in a manner as follows.

Computer system 500 includes a bus 502 or other communication mechanism for communicating information data, signals, and information between various components of computer system 500. Components include an input component 504 that processes a user action, such as selecting keys from a keypad/keyboard, selecting one or more buttons or links, etc., and sends a corresponding signal to bus 502. A transceiver 506 transmits and receives signals between computer system 500 and other devices, such as a merchant server, payment provider server, or another user device. In one embodiment, the transmission is wireless, although other transmission mediums and methods may also be suitable. A display 508, such as an LCD screen, display an image, such as the various pages seen during a DLFS option process. A processor 512, which can be a micro-controller, digital signal processor (DSP), or other processing component, processes these various signals, such as for display on computer system 500 or transmission to other devices via a communication link 518. Processor 512 may determine the amount of funds used from each funding source for a payment.

Components of computer system 500 also include a system memory component 514 (e.g., RAM) and a static storage component 516 (e.g., ROM). Computer system 500 performs specific operations by processor 512 and other components by executing one or more sequences of instructions contained in system memory component 514. Logic may be encoded in a computer readable medium, which may refer to any medium that participates in providing instructions to processor 512 for execution. Such a medium may take many forms, including but not limited to, non-volatile media, volatile media, and transmission media. In various implementations, non-volatile media includes optical or magnetic disks, volatile media includes dynamic memory, such as system memory component 514, and transmission media includes coaxial cables, copper wire, and fiber optics, including wires that comprise bus 502. In one example, transmission media may take the form of acoustic or light waves, such as those generated during radio wave, optical, and infrared data communications.

Some common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, carrier wave, or any other medium from which a computer is adapted to read.

In various embodiments, execution of instruction sequences to practice the present disclosure may be performed by computer system 500. In various other embodiments of the present disclosure, a plurality of computer systems 500 coupled by communication link 518 to the network (e.g., such as a LAN, WLAN, PTSN, and/or various other wired or wireless networks, including telecommunications, mobile, and cellular phone networks) may perform instruction sequences to practice the present disclosure in coordination with one another.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software, in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

The foregoing disclosure is not intended to limit the present disclosure to the precise forms or particular fields of use disclosed. As such, it is contemplated that various alternate embodiments and/or modifications to the present disclosure, whether explicitly described or implied herein, are possible in light of the disclosure. Having thus described embodiments of the present disclosure, persons of ordinary skill in the art will recognize that changes may be made in form and detail without departing from the scope of the present disclosure. Thus, the present disclosure is limited only by the claims.

What is claimed is:

1. A method for performing a financial transaction, comprising:
receiving a payment request for a first amount;
determining whether the first amount is less than or equal to a first limit of a first funding source having a first priority and the first limit defined by a user;
funding the first amount entirely from the first funding source if the first amount is less than or equal to the first limit of the first funding source; and
if the first amount is greater than the first limit, funding the first amount from the first funding source in an amount equal to the first limit; determining whether a remaining amount is less than or equal to a second limit of a second funding source having a second priority and the second limit defined by the user; and funding the remaining amount entirely from the second funding source if the remaining amount is less than or equal to the second limit of the second funding source.

2. The method of claim 1, further comprising:
if the remaining amount is greater than the second limit, funding the remaining amount from the second funding source in an amount equal to the second limit;
determining whether a second remaining amount is less than or equal to a third limit of a third funding source having a third priority and the third limit defined by the user; and
funding the second remaining amount entirely from the third funding source if the second remaining amount is less than or equal to the third limit of the third funding source.

3. The method of claim 1, wherein the first and second funding sources are selected from a group consisting of credit cards, bank accounts, and payment provider accounts.

4. The method of claim 1, wherein the first and second funding sources are different.

5. The method of claim 1, wherein the payment request is received from the user.

6. The method of claim 1, wherein the payment request is received from a merchant.

7. The method of claim 1, further comprising providing the user an option to change the first limit, the second limit, the first priority, or the second priority.

8. The method of claim 1, further comprising providing the user an option to add a new funding source and define a limit and a priority for the new funding source.

9. The method of claim 1, wherein the first and second limits are dynamically changeable by the user.

10. The method of claim 1, wherein the receiving, determining, and funding are by a merchant.

11. The method of claim 1, wherein the receiving, determining, and funding are by a payment provider.

12. An apparatus comprising:
a tangible computer-readable storage structure storing a computer program that, when executed by one or more processors, performs a method comprising:
receiving a payment request for a first amount;
determining whether the first amount is less than or equal to a first limit of a first funding source having a first priority and the first limit defined by a user;
funding the first amount entirely from the first funding source if the first amount is less than or equal to the first limit of the first funding source; and
if the first amount is greater than the first limit, funding the first amount from the first funding source in an amount equal to the first limit; determining whether a remaining amount is less than or equal to a second limit of a second funding source having a second priority and the second limit defined by the user; and funding the remaining amount entirely from the second funding source if the remaining amount is less than or equal to the second limit of the second funding source.

13. The apparatus of claim 12, wherein the method further comprises:
if the remaining amount is greater than the second limit, funding the remaining amount from the second funding source in an amount equal to the second limit;
determining whether a second remaining amount is less than or equal to a third limit of a third funding source having a third priority and the third limit defined by the user; and
funding the second remaining amount entirely from the third funding source if the second remaining amount is less than or equal to the third limit of the third funding source.

14. The apparatus of claim 13, wherein the first and second funding sources are selected from a group consisting of credit cards, bank accounts, and payment provider accounts.

15. The apparatus of claim 13, wherein the method further comprises providing the user an option to change the first limit, the second limit, the first priority, or the second priority.

16. The apparatus of claim 13, wherein the method further comprises providing the user an option to add a new funding source and define a limit and a priority for the new funding source.

17. The apparatus of claim 13, wherein the first and second limits are dynamically changeable by the user.

18. The apparatus of claim 13, wherein the receiving, determining, and funding are by a merchant.

19. The apparatus of claim 13, wherein the receiving, determining, and funding are by a payment provider.

20. An on-line payment processing system comprising:
means for receiving a payment request for a first amount;
means for determining whether the first amount is less than or equal to a first limit of a first funding source having a first priority and the first limit defined by a user;
means for funding the first amount entirely from the first funding source if the first amount is less than or equal to the first limit of the first funding source; and
if the first amount is greater than the first limit, the funding means funding the first amount from the first funding source in an amount equal to the first limit; the determining means determining whether a remaining amount is less than or equal to a second limit of a second funding source having a second priority and the second limit defined by the user; and the funding means funding the remaining amount entirely from the second funding source if the remaining amount is less than or equal to the second limit of the second funding source.

21. The system of claim 20, further comprising:
if the remaining amount is greater than the second limit, the funding means funding the remaining amount from the second funding source in an amount equal to the second limit;
the determining means determining whether a second remaining amount is less than or equal to a third limit of a third funding source having a third priority and the third limit defined by the user; and
the funding means funding the second remaining amount entirely from the third funding source if the second remaining amount is less than or equal to the third limit of the third funding source.

22. The system of claim 20, wherein the first and second funding sources are selected from a group consisting of credit cards, bank accounts, and payment provider accounts.

23. The system of claim 20, further comprising means for providing the user an option to change the first limit, the second limit, the first priority, or the second priority.

24. The system of claim 20, wherein the first and second limits are dynamically changeable by the user.

25. A method for performing a financial transaction, comprising:
receiving a payment request for a first amount; and
funding the first amount from N funding sources, each funding source having a user-defined priority of 1 to M, wherein the funding comprises sequentially funding from a priority 1 funding source to a priority M funding source up to a user-defined limit for each funding source until the first amount is fully funded or the N funding sources are exhausted.

26. The method of claim 25, wherein M is less than or equal to N.

27. The method of claim 25, wherein the N funding sources are selected from a group comprising credit cards, bank accounts, and payment provider accounts.

28. The method of claim 25, further comprising providing a user an option to change the limit or priority of any of the funding sources.
